(19) United States
(12) Patent Application Publication
(10) Pub. No.: US 2005/0237354 A1
(43) Pub. Date: Oct. 27, 2005

(54) Selection of printheads via enable lines

(76) Inventor: Jason M. Quintana, Brush Prairie, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/831,805

(22) Filed: Apr. 25, 2004

(51) Int. Cl. B41J 29/38

(52) U.S. Cl. 347/12

(57) ABSTRACT

A method of an embodiment of the invention, for each intended one of a plurality of printheads to eject fluid, selects the intended one of the plurality of printheads via one or more enable lines coupled to the plurality of printheads, and provides data for the intended one of the plurality of printheads to all of the plurality of printheads.

### BACKGROUND

Inkjet printers have become popular for printing on media. For instance, such printers have become popular for printing color image files generated using digital cameras, for printing color copies of business presentations, and so on. An inkjet printer is more generically a fluid-ejection device that ejects fluid, such as ink, onto media, such as paper.

Inkjet printers work by having a number of inkjet printheads, or inkjet pens, each of which being capable of ejecting ink onto media. A given inkjet printhead or pen usually has a large number of individual nozzles, and each nozzle is able to independently eject ink. To increase the resulting print, or output, quality of an inkjet printer, the number of inkjet printheads and/or the number of nozzles within each printhead may be increased.

However, increasing the number of inkjet printheads or the number of nozzles within each printhead can increase manufacturing costs for the inkjet printers of which they are a part because driver electronics may be used for each added printhead.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a top-view diagram of a representative fluid-ejection assembly having an embodiment of fluid-ejection printheads capable of ejecting fluid onto media, according to an embodiment of the invention.

FIG. 2 is a bottom-view diagram of a representative fluid-ejection printhead having a number of nozzles connected by data lines, including address lines and primitive lines, according to an embodiment of the invention.

FIG. 3 is block diagram of a fluid-ejection assembly having an embodiment of fluid-ejection printheads that share common fluid-ejection driver electronics, such that the printheads are individually selectable via enable lines, according to an embodiment of the invention.

FIGS. 4A and 4B are block diagrams of embodiments of fluid-ejection assemblies having embodiments of fluid-ejection printheads that share common fluid-ejection driver electronics, but having different topologies of enable lines connecting the electronics to the printheads, according to varying embodiments of the invention.

FIG. 5 is a flowchart of an embodiment of a method for ejecting fluid from fluid-ejection printheads of a fluid-ejection assembly that share the same fluid-ejection driver electronics, according to an embodiment of the invention.

FIG. 6 is a flowchart of an embodiment of a method for manufacturing a fluid-ejection assembly having fluid-ejection printheads that share the same fluid-ejection driver electronics, according to an embodiment of the invention.

FIG. 7 is a block diagram of an embodiment of a fluid-ejection device, such as an inkjet-printing device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments. These embodiments are described in sufficient detail to enable those skilled in the art to practice the embodiments of the invention. Other embodiments may be utilized, and logical, mechanical, and other changes may be made without departing from the spirit or scope of the claimed subject matter. The following detailed description is, therefore, not to be taken in a limiting sense, and the scope of the present invention is defined only by the appended claims.

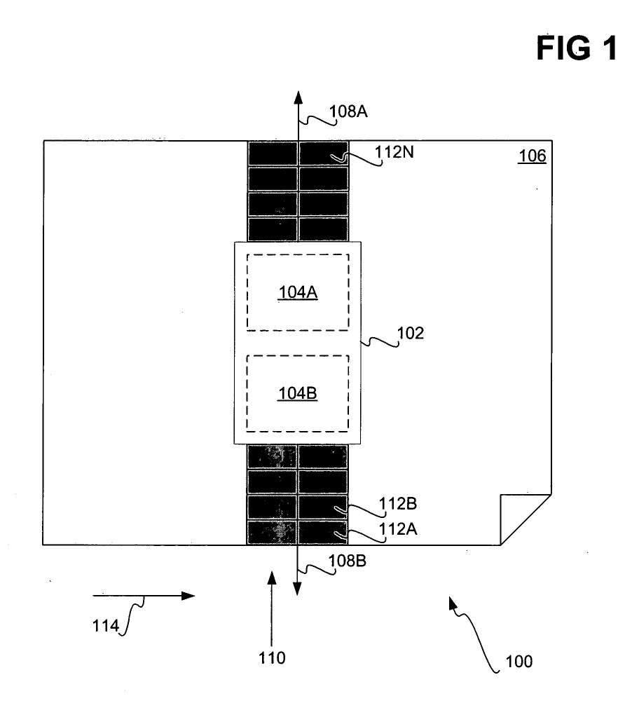

FIG. 1 shows a top view of a representative fluid-ejection assembly 100 relative to a sheet of media 106, according to an embodiment of the invention. The fluid-ejection assembly 100 includes a carriage 102 in which two printheads such as fluid-ejection printheads 104A and 104B, collectively referred to as the fluid-ejection printheads 104, are disposed. The fluid-ejection printheads 104 are capable of ejecting fluid onto the media 106. The fluid-ejection printheads 104 may be inkjet printheads, or inkjet pens, that are capable of ejecting ink onto the media 106, in which case the fluid-ejection assembly 100 may be referred to as an inkjet-printing assembly. In one embodiment, the printhead 104A may be a black inkjet printhead, or pen, and the printhead 104B may be a color inkjet printhead, or pen. The media 106 may be paper, or another type of media.

The carriage 102 of the fluid-ejection assembly 100 is movable latitudinally over the sheet of media 106, as indicated by arrows 108A and 108B, which are collectively referred to as the arrows 108. Furthermore, the media 106 itself is movable longitudinally under the carriage 102, as indicated by arrow 114. The width of the media 106 over which the fluid-ejection assembly 100 can currently move, based on the current position of the carriage 102 relative to the length of the media 106, is referred to as a current swath 110 of the media 106. The current swath 110 is divided into a number of positions 112A, 112B, . . . , 112N, collectively referred to as the positions 112. The current position of the positions 112 of the swath 110 is the position under the carriage 102 at which one of the fluid-ejection printheads 104 is currently able to eject fluid onto the sheet of media 106.

At the current swath 110 of the sheet of media 106, the carriage 102 moves over each of the positions 112. At each of the positions 112, first one of the fluid-ejection printheads 104 may eject fluid at the position on the swath 110 of the media 106, and then the other of the printheads 104 may eject fluid at this position. Once the carriage 102 has moved over all of the positions 112 of the swath 110, the media 106 is advanced, as indicated by the arrow 114, so that a new swath is the current swath 110, and the carriage 102 is moved over this new swath. This process is repeated until fluid has been ejected onto the sheet of media 106 as desired. In another embodiment of the invention, the printheads 104 may be fixed, such that they do not move at all. In this embodiment of the invention, the printheads 104 may still be disposed within the carriage 102, but the carriage 102 may itself be fixed and not moveable. Alternatively, the printheads 104 may not be disposed within a carriage like the carriage 102.

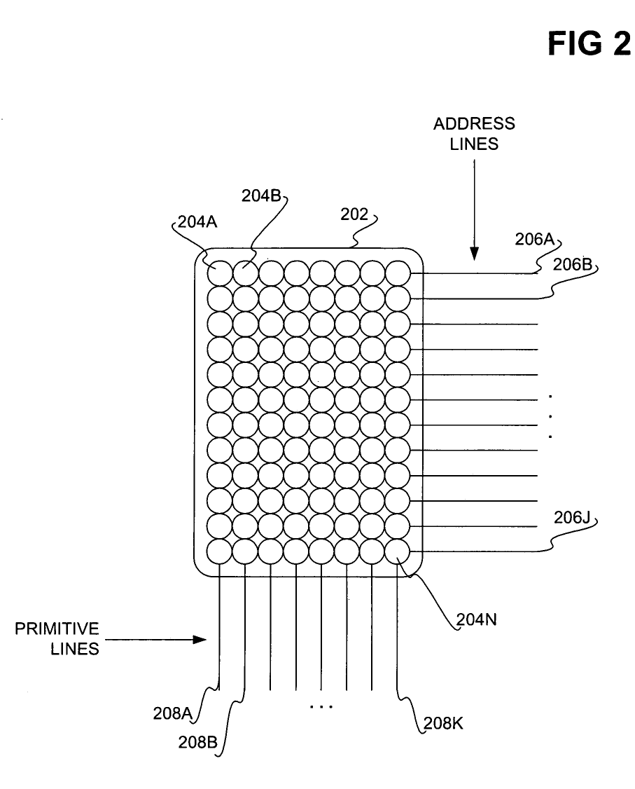

FIG. 2 shows a bottom view of a fluid-ejection printhead 202, according to an embodiment of the invention. The fluid-ejection printhead 202 may implement either or both of the fluid-ejection printheads 104 of the fluid-ejection assembly 100 of FIG. 1, and is an example of one embodiment of the printheads 104. The printhead 202 includes a matrix of fluid-ejection nozzles 204A, 204B, . . . , 204N, collectively referred to as the nozzles 204. Each of the fluid-ejection nozzles 204 is capable of independently ejecting fluid, such as ink, in which case the nozzles 204 are specifically inkjet nozzles. As depicted in FIG. 2, there are ninety-six of the nozzles 204, organized in and addressable as a matrix of eight columns and twelve rows. However, such a number of the nozzles 204 and such organization of the nozzles 204 are for example purposes only, and other embodiments of the invention may have different numbers of the nozzles 204 and/or that are organized differently than as depicted in FIG. 2.

The fluid-ejection nozzles 204 of the fluid-ejection printhead 202 are connected to data lines, including address lines 206A, 206B, . . . , 206J, which are collectively referred to as the address lines 206, and primitive lines 208A, 208B, . . . , 208K, which are collectively referred to as the primitive lines 208. Each of the address lines 206 is connected to all of the nozzles 204 within a given row, whereas each of the primitive lines 208 is connected to all of the nozzles 204 within a given column. Therefore, each of the nozzles 204 is independently selectable by asserting the address line of the row within which a given nozzle is located and by asserting the primitive line of the column within which this nozzle is located. Selecting one of the nozzles 204 may cause, for instance, the nozzle to eject fluid, or fire. Providing data to the fluid-ejection printhead 202 encompasses repeatedly selecting address lines and primitive lines to cause one or more of the nozzles 204 to fire as desired.

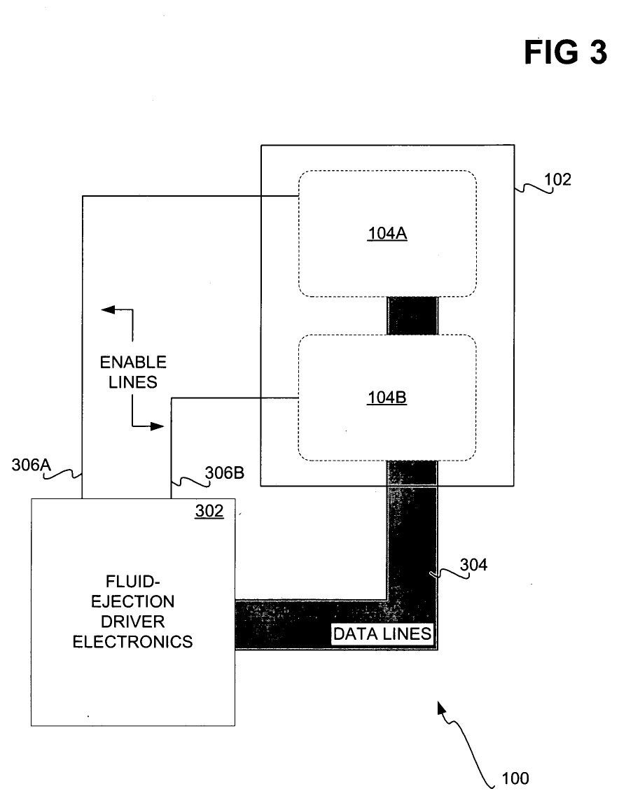

FIG. 3 shows the fluid-ejection assembly 100 of FIG. 1 in more detail, according to an embodiment of the invention. As before, the assembly 100 includes fluid-ejection printheads 104 disposed within the carriage 102. The fluid-ejection assembly 100 also includes electronics, such as fluid-ejection driver electronics 302, which are communicatively coupled to the fluid-ejection printheads 104 via data lines 304 and enable lines 306A and 306B, collectively referred to as the enable lines 306. The fluid-ejection driver electronics 302 include the electronics used to select nozzles of the fluid-ejection printheads 104 to eject ink as the carriage 102 moves over a current swath of the media 106, which is not shown in FIG. 3. The fluid-ejection driver electronics 302 are shared by all of the fluid-ejection printheads 104 of the fluid-ejection assembly 100.

The data lines 304 may include primitive lines and address lines, such as the primitive lines 208 and the address lines 206 of FIG. 2, in one embodiment of the invention. The same data lines 304 are connected to both of the fluid-ejection printheads 104. For example, where the data lines 304 include primitive lines and address lines, each primitive line is communicatively coupled to one of the columns of nozzles of the printhead 104A, and to one of the columns of nozzles of the printhead 104B. Similarly, each address line is communicatively coupled to one of the rows of nozzles of the printhead 104A, and to one of the rows of nozzles of the printhead 104B. Such common connection of the data lines 304 to all of the printheads 104 means that the data intended for one of the printheads 104 is sent to the other of the printheads 104, too.

Therefore, the enable lines 306 are present to allow the fluid-ejection driver electronics 302 to specify which of the printheads 104 is to act on the data being provided by the electronics 302 on the data lines 304. In the embodiment of FIG. 3, there are two data lines 306 corresponding to the two fluid-ejection printheads 104. The fluid-ejection driver electronics 302, for example, selects the enable line 306A when the data being provided on the data lines 304 is intended for the printhead 104A, and selects the enable line 306B when the data on the data lines 304 is intended for the printhead 104B.

The presence of the enable lines 306 within the fluid-ejection assembly 100 of FIG. 3 allows the fluid-ejection driver electronics 302, as well as the data lines 304, to be shared among all of the fluid-ejection printheads 104. Additional fluid-ejection printheads may be added to the printheads 104, for instance, without having to add corresponding fluid-ejection driver electronics, which can be costly. That is, because all of the printheads 104 share the same driver electronics 302, the cost of adding additional printheads is reduced. Furthermore, the fluid-ejection assembly 100 may be able to be made smaller, since different driver electronics 302 are not used for each individual fluid-ejection printhead. The electronics 302 are able to provide data on the data lines 304 at different times for different intended ones of the fluid-ejection printheads 104, by differently and correspondingly asserting the enable lines 306 while the carriage 102 is moving over the current swath 110 of the media 108 of FIG. 1. Furthermore, fluid is ejected onto the current swath 110 of the media 108 in one pass of the carriage 102 over the current swath 100.

In addition, sharing of the fluid-ejection driver electronics 302 among the fluid-ejection printheads 104 is inclusive of and encompasses sharing a portion of the driver electronics 302 among the printheads 104, where there are other portions dedicated and corresponding to each of the printheads 104. For example, the electronics 302 may include a decision-making portion that decides whether or not to fire a given nozzle of any of the printheads 104, where this portion is shared by all of the printheads 104. The electronics 302 may further include a command-sending portion for each of the printheads 104, where this command-sending portion conveys the decision made by the decision-making portion with respect to a particular one of the printheads 104 as a command to that particular printhead. That is, the decision-making portion of the electronics 302 knows which of the command-sending portions to send a nozzle-fire decision to, specifically sending a given nozzle-fire decision to the command-sending portion corresponding to the printhead that encompasses or includes the nozzle that is the subject of the given nozzle-fire decision.

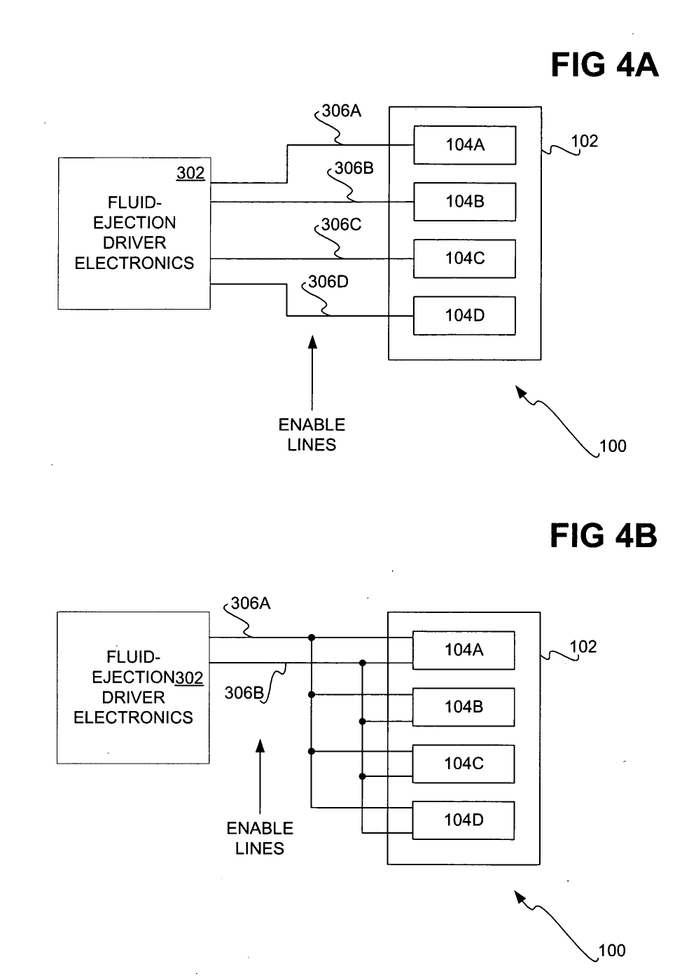

FIGS. 4A and 4B show different topologies as to how the enable lines 306 may be connected to the fluid-ejection printheads 104 disposed within the carriage 102 of the fluid-ejection assembly 100, according to varying embodiments of the invention. In both FIGS. 4A and 4B, there are four fluid-ejection printheads 104A, 104B, 104C, and 104D, as an additional example different from that of FIGS. 1 and 3. Furthermore, the data lines 304 of FIG. 3 are not depicted in FIGS. 4A and 4B for illustrative clarity. Each of the printheads 104 corresponds to a unique assertion of the enable lines 306 in both FIGS. 4A and 4B, as is now particularly described.

In FIG. 4A, the fluid-ejection driver electronics 302 are connected to the fluid-ejection printheads 104 by individual enable lines 306, which include four enable lines 306A, 306B, 306C, and 306D corresponding to the printheads 104A, 104B, 104C, and 104D. That is, the printhead 104A is connected to the fluid-ejection driver electronics 302 via the enable line 306A, the printhead 104B is connected to the driver electronics 302 via the enable line 306B, the printhead 104C is connected to the electronics 302 via the enable line 306C, and the printhead 104D is connected via the enable line 306D. Therefore, when the electronics 302 provides data on the data lines for an intended one of the printheads 104, it selects or asserts the corresponding one of the enable lines 306. For example, when the electronics 302 provides data for the printhead 104C, it selects the enable line 306C to indicate that the data is intended just for the printhead 104C.

By comparison, in FIG. 4B, the fluid-ejection driver electronics 302 are connected to the fluid-ejection printheads 104 by multiplexed enable lines 306 that are all connected to each of the printheads 104 and which include the enable lines 306A and 306B. That is, each of the printheads 104A, 104B, 104C, and 104D is connected to both the enable line 306A and the enable line 306B. To select an intended one of the printheads 104, the driver electronics 302 asserts, or does not assert, the enable lines 306 in a unique way that corresponds to the intended printhead. For example, the electronics 302 may assert neither of the enable lines 306 to select the printhead 104A, just the enable line 306A to select the printhead 104B, just the enable line 306B to select the printhead 104C, and both of the enable lines 306 to select the printhead 104D.

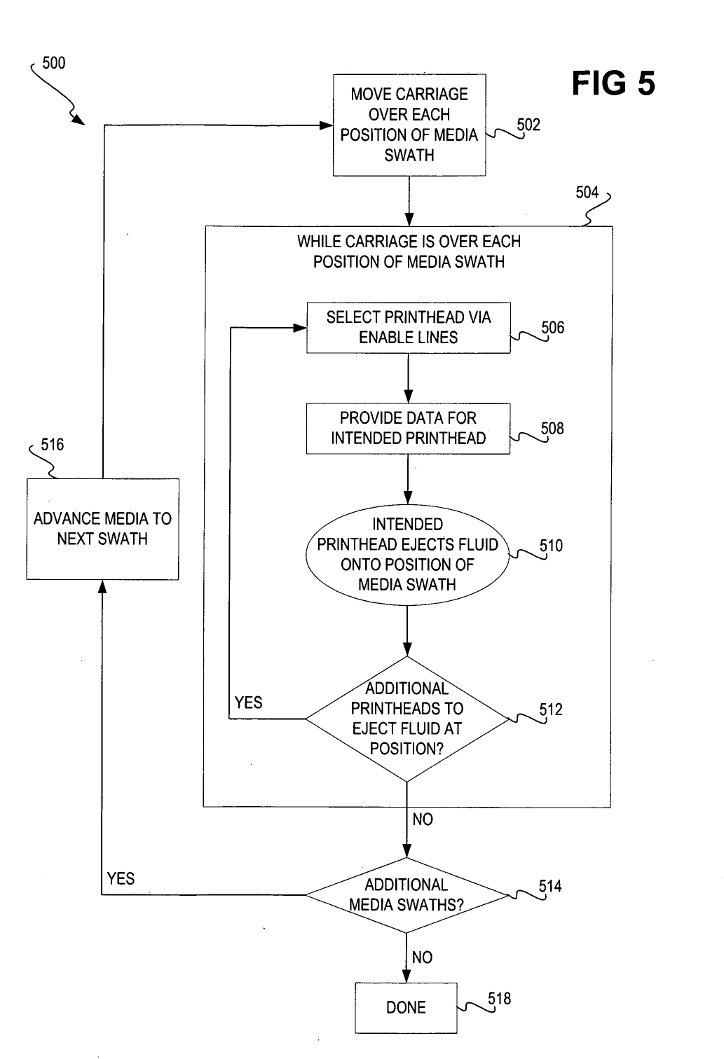

FIG. 5 shows a method 500 for the fluid-ejection printheads of a fluid-ejection assembly that share the same fluid-ejection driver electronics to eject fluid onto media, according to an embodiment of the invention. The method 500 may, for instance, be performed by the fluid-ejection assembly 100 that has been described, which includes fluid-ejection printheads 104 sharing the same fluid-ejection driver electronics 302. The method 500 may be performed by other types of fluid-ejection assemblies, including other types of inkjet-printing assemblies, as well.

The carriage of the fluid-ejection assembly within which the fluid-ejection printheads are disposed is moved over each position of a current swath of media (502). While the carriage is over each position of this media swath (504), one of the fluid-ejection printheads that is to eject fluid at this position is selected via one or more enable lines (506). The enable lines communicatively couple the fluid-ejection printheads to the fluid-ejection driver electronics, and can be asserted so that a single one of the printheads is selected. The driver electronics provides data for the intended printhead on data lines that are common to all of the printheads (508). Because just an intended one of the fluid-ejection printheads has been selected, however, just the intended printhead ejects fluid onto the current position of the media swath (510). Data may be provided by repeatedly selecting primitive lines and address lines so that each nozzle of the printhead that is to eject fluid at the current position of the media swath is selected.

If the fluid-ejection assembly includes additional fluid-ejection printheads that are to eject fluid at the current position of the media swath (512), then the process of 506, 508, and 510 is repeated for each such fluid-ejection printhead. In one embodiment of the invention, the process of selecting an intended fluid-ejection printhead in 506 can be considered toggling the enable lines to alternatively select the different printheads. For example, where there are two printheads, first the enable line connecting the fluid-ejection driver electronics to one of the printheads is asserted, and then the enable line connecting the driver electronics to the other printhead is asserted.

Once all the fluid-ejection printheads that are to eject fluid at the current position of the media swath have done so, if there are additional swaths of media onto which fluid is to be ejected (514), then the media is advanced so that the next swath is under the carriage (516), and the method 500 is repeated at 502. Otherwise, the method 500 is finished (518). The method 500 provides for ejecting fluid by all the fluid-ejection printheads of the fluid-ejection assembly over each swath of media in one pass over each swath of media, by alternatively and successively selecting the printheads via the enable lines as the carriage in which the printheads are disposed moves over the swath of media.

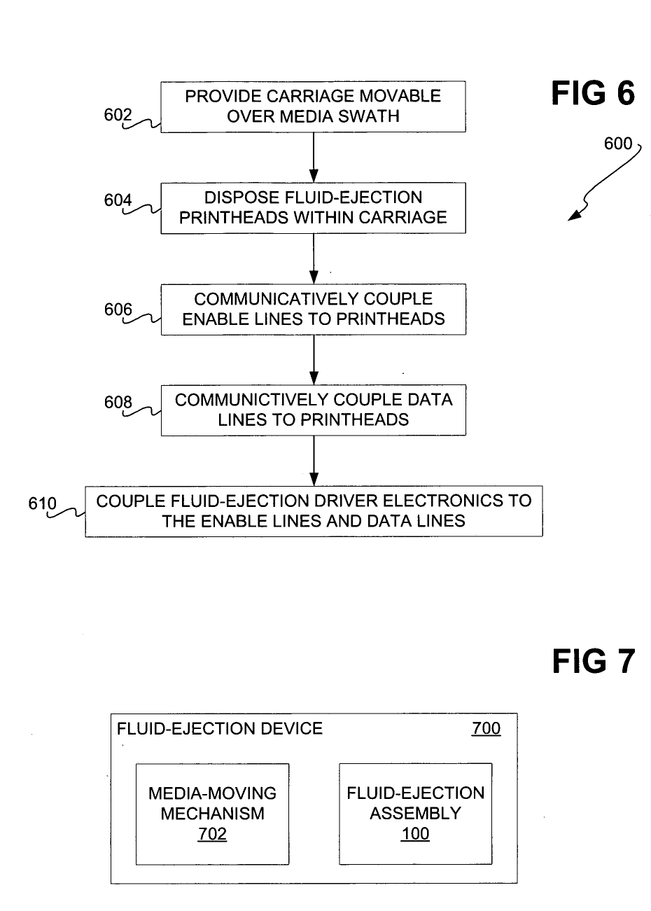

FIG. 6 shows a method 600 for manufacturing a fluid-ejection assembly having fluid-ejection printheads that share the same fluid-ejection driver electronics, according to an embodiment of the invention. The method 600 may, for instance, be performed to manufacture the fluid-ejection assembly 100 that has been described, which includes fluid-ejection printheads 104 sharing the same fluid-ejection driver electronics 302. The method 600 may be performed to manufacture others types of fluid-ejection assemblies, including other types of inkjet-printing assemblies, as well.

A carriage is first provided that is movable over a media swath (602). Fluid-ejection printheads are disposed within the carriage (604). Enable lines are communicatively coupled to the fluid-ejection printheads that allow for the printheads to be individually selected (606). Likewise, data lines are communicatively coupled to the fluid-ejection printheads that allow for the printheads to be provided with data for ejecting fluid onto media (608). Finally, fluid-ejection driver electronics that are common to all the printheads are communicatively coupled to the enable lines and the data lines (610). The electronics are capable of providing data on the data lines at different times, for different intended printheads, by differently and correspondingly asserting the enable lines while the carriage is moving over a given swath of media.

FIG. 7 shows a block diagram of a representative fluid-ejection device 700, according to an embodiment of the invention. The fluid-ejection device 700 includes a media-moving mechanism 702, as well as the fluid-ejection assembly 100 that has been described and which includes fluid-ejection printheads 104 that share the same fluid-ejection driver electronics 302. The media-moving mechanism 702 includes those components that enable media to be moved under the carriage 102 of the assembly 100, as indicated by the arrow 114 in FIG. 1. As such, the mechanism 702 may includes rollers, motors, guides, and other types of components. Furthermore, as can be appreciated by those of ordinary skill within the art, the fluid-ejection device 700 may include other components, in addition to and/or in lieu of those depicted in FIG. 7.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present disclosure. Therefore, it is manifestly intended that this invention be limited only by the claims and equivalents thereof.

1. A method comprising:
for each intended one of a plurality of printheads to eject fluid,
selecting the intended one of the plurality of printheads via one or more enable lines coupled to the plurality of printheads; and,
providing data for the intended one of the plurality of printheads to all of the plurality of printheads.

2. The method of claim 1, further comprising initially moving a carriage having the plurality of printheads over a media swath having a plurality of positions, such that selecting the intended one of the plurality of printheads and providing data for the intended one of the plurality of printheads are accomplished at each position of the media swath.

3. The method of claim 2, wherein all of the plurality of printheads are to eject fluid onto the media swath within one pass of the carriage over the media swath by differently and individually selecting the plurality of printheads via the one or more enable lines.

4. The method of claim 2, wherein moving the carriage over the media swath comprises moving the carriage over the media swath in one pass.

5. The method of claim 1, wherein a common fluid-ejection driver electronics for all of the plurality of printheads selects the intended one of the plurality of printheads via the one or more enable lines, and provides the data for the intended one of the plurality of printheads to all of the plurality of printheads.

6. The method of claim 1, wherein providing the data for the intended one of the plurality of printheads comprises providing the data to all of the plurality of printheads via data lines communicatively coupled to each of the plurality of printheads.

7. The method of claim 1, wherein providing the data for the intended one of the plurality of printheads comprises repeating one or more times: selecting an address line of a plurality of address lines and selecting a primitive line of a plurality of primitive lines by which nozzles of the intended one of the plurality of printheads are addressable as a matrix.

8. The method of claim 1, wherein the plurality of printheads comprises a plurality of fluid-ejection pens.

9. The method of claim 1, wherein the plurality of printheads comprises a black printhead and at least one color printhead.

10. The method of claim 1, wherein the carriage is part of an image-forming device, such that the plurality of printheads of the carriage is a plurality of inkjet printheads.

11. A method comprising:
selectively toggling an enable line coupled to a black printhead and a color printhead to alternatively select the black printhead and the color printhead; and,
as each printhead of the black printhead and the color printhead is selected, providing data for the printhead selected, via data lines communicatively coupled to both the black printhead and the color printhead.

12. The method of claim 11, further comprising initially moving a carriage having the black printhead and the color printhead within one pass over a media swath having a plurality of positions, such that selectively toggling the enable line and providing data for the printhead selected are accomplished at each position of the plurality of positions of the media swath.

13. The method of claim 12, wherein both the black printhead and the color printhead are to eject fluid onto the media swath within the one pass of the carriage over the media swath by differently and individually selecting the black printhead and the color printhead via selectively toggling the enable line.

14. The method of claim 11, wherein a common fluid-ejection driver electronics for both the black-fluid ejection printhead and the color printhead selects the intended one of the plurality of printheads via the one or more enable lines, and provides the data for the intended one of the plurality of printheads to all of the plurality of printheads.

15. The method of claim 11, wherein providing the data for the printhead selected comprises repeating one or more times: selecting an address line of a plurality of address lines and selecting a primitive line of a plurality of primitive lines by which nozzles of the printhead selected are addressable as a matrix.

16. The method of claim 11, wherein the carriage is part of an image-forming device, such that the black printhead of the carriage is a black pen and the color printhead of the carriage is a color pen.

17. A fluid-ejection assembly comprising:
a plurality of printheads;
one or more enable lines coupled to the plurality of printheads;
a plurality of data lines coupled to the plurality of printheads; and,
electronics to provide data on the plurality of data lines for different ones of the plurality of printheads by differently and correspondingly asserting the one or more enable lines.

18. The assembly of claim 17, wherein the plurality of printheads comprises a black printhead and at least one color printhead.

19. The assembly of claim 17, wherein the plurality of data lines comprises a plurality of address lines and a plurality of primitive lines by which nozzles of the plurality of printheads are addressable as a matrix.

20. The assembly of claim 17, further comprising a carriage movable over a media swath, the plurality of printheads disposed within the carriage.

21. The assembly of claim 20, wherein the media swath has a plurality of positions, such that while the carriage is over each position the fluid-ejection driver electronics is to provide data on the plurality of data lines for the plurality of printheads to eject fluid at the position, in order, by successively performing the unique assertion of the one or more enable lines to which each of the plurality of printheads corresponds.

22. The assembly of claim 17, wherein the electronics comprises a portion of the electronics being common the plurality of printheads and another portion corresponding to each printhead of the plurality of printheads.

23. The assembly of claim 17, wherein the plurality of printheads is a plurality of inkjet printheads, such that the fluid-ejection assembly is an inkjet-printing assembly.

24. A fluid-ejection assembly comprising:
a carriage movable over a media swath;
a plurality of printheads disposed within the carriage and having a plurality of nozzles;
one or more enable lines communicatively coupled to the plurality of printheads, each of the plurality of printheads corresponding to a unique assertion of the one or more enable lines;
a plurality of address lines and a plurality of primitive lines by which the plurality of nozzles of each of the plurality of printheads is addressable; and,
means for providing data on the plurality of data lines at different times for different intended ones of the plurality of printheads by differently and correspondingly asserting the one or more enable lines while the carriage is moving over the media swath.

25. The assembly of claim 24, wherein the media swath has a plurality of positions, such that while the carriage is over each position the means is to provide data on the plurality of data lines for the plurality of printheads to eject fluid at the position, in order, by successively performing the unique assertion of the one or more enable lines to which each of the plurality of printheads corresponds.

26. The assembly of claim 24, wherein the plurality of printheads comprises a black inkjet pen and at least one color inkjet pen, such that the fluid-ejection assembly is an inkjet-printing assembly.

27. A fluid-ejection device comprising:
a media-moving assembly to move media through the fluid-ejection device; and,
a fluid-ejection assembly to eject fluid on swaths of the media as the media-moving assembly moves the media, the assembly having a plurality of printheads that are provided with data via common data lines, and alternatively selected over each swath of the media via one or more enable lines.

28. The fluid-ejection device of claim 27, wherein the fluid-ejection assembly comprises:
a carriage movable over each swath of the media;
the plurality of printheads disposed within the carriage;
the one or more enables lines communicatively coupled to the plurality of printheads, each of the plurality of printheads corresponding to a unique assertion of the one or more enable lines;
the common data lines communicatively coupled to the plurality of printheads; and,
fluid-ejection driver electronics common to the plurality of printheads, to provide the data on the common data lines at different times for different intended ones of the plurality of printheads by differently and correspondingly asserting the one or more enable lines while the carriage is moving over each swath of the media.

29. The fluid-ejection device of claim 27, wherein the plurality of printheads comprises a black ink pen and at least one color ink pen, such that the fluid-ejection device is an inkjet-printing device.

30. A fluid-ejection device comprising:
a media-moving assembly to move media through the fluid-ejection device; and,
means for ejecting fluid on swaths of the media as the media-moving assembly moves the media using a plurality of printheads that are provided with data via common data lines, and alternatively selected over each swath of the media via one or more enable lines.

31. The fluid-ejection device of claim 30, wherein the plurality of printheads comprises a black ink pen and at least one color ink pen, such that the fluid-ejection device is an inkjet-printing device.

32. A method for constructing a fluid-ejection assembly comprising:
coupling one or more enable lines to a plurality of printheads;
coupling a plurality of data lines to the plurality of printheads; and,
coupling fluid-ejection driver electronics for all of the plurality of printheads to the one or more enable lines and to the plurality of data lines, the fluid-ejection driver electronics capable of providing data on the plurality of data lines at different times for different intended ones of the plurality of printheads by differently and correspondingly asserting the one or more enable lines.

33. The method of claim 32, further comprising:
providing a carriage movable over a media swath; and,
disposing the plurality of printheads within the carriage.
